(19) United States
(12) Patent Application Publication
(10) Pub. No.: US 2026/0320105 A1
(43) Pub. Date: Oct. 15, 2026

(54) ADAPTIVE MULTI-DOMAIN CHATBOT SYSTEM

(71) Applicant: GRABTAXI HOLDINGS PTE. LTD., Singapore (SG)

(72) Inventors: Meihan LIU, Singapore (SG); Anthony Ping Yeow TAN, Singapore (SG); Nikhil DWARAKANATH, Singapore (SG); Rembrand Michael KONING, Cambridge, MA (US); Hyunjin KIM, Singapore (SG); Christopher Lukas COLLARD, Singapore (SG); Bhargav Vadhiraja SRINIVAS, Singapore (SG)

(21) Appl. No.: 19/630,825

(22) Filed: Mar. 27, 2026

(30) Foreign Application Priority Data
Apr. 15, 2025 (SG) 10202500981S
Aug. 25, 2025 (SG) 10202502405X

(51) Int. Cl. G06F 16/432

(52) U.S. Cl. CPC G06F 16/432

(57) ABSTRACT

A computer-implemented method for an adaptive multi-domain chatbot system receives a user query via text, audio, or video, and determines a relevant functional domain based on user-specific contextual data. The query is routed to a domain-specific processing module among multiple modules, each linked to distinct functional domains. Based on domain-level context, one or more tools from a centralized repository are selected and executed to process the query. The system generates interactive action cards displayed on a graphical user interface, allowing user interaction, wherein inputs from the user trigger execution of associated operations. The method includes intent identification for domain routing, dynamic generation of domain-specific prompts, and application of system-level parameters to standardize response tone, formatting, compliance, and interaction behavior.

### FIELD OF INVENTION

The present invention relates generally to chatbot systems and, more particularly, to a computer-implemented adaptive chatbot system that leverages large language models (LLMs), contextual domain detection, dynamic tool invocation, and user-facing action cards to support multi-domain business operations

### BACKGROUND OF INVENTION

Chatbot systems have become integral to digital platforms, particularly in domains such as customer service, business process automation, and merchant support. These systems are designed to simulate conversational interactions between users and service providers through natural language interfaces. Their applications span a wide range of functions including order tracking, product inquiries, knowledge base access, and task execution. Despite their growing adoption, conventional chatbot systems exhibit serious technical limitations that reduce their effectiveness, particularly in complex, multi-functional environments such as retail, e-commerce, and quick-service business operations.

One major limitation of existing chatbot systems is their domain-specific design. Most implementations are tailored to operate within a single functional domain or a tightly scoped set of tasks. For instance, a chatbot deployed to manage menu item updates is typically unable to also handle promotional campaign analytics or respond to sales performance queries without manual configuration or dedicated integrations. This lack of cross-domain adaptability fragments the user experience, requiring users to interact with multiple bots or systems to complete workflows that span operational silos.

From a technical perspective, existing chatbot systems can generally be categorized into two broad types: template-driven systems and intent-based modular systems. Template-driven systems rely on predefined scripts, static decision trees, or rule-based logic to generate responses. These are easy to implement but offer limited flexibility, minimal contextual awareness, and cannot support dynamic content. Intent-based systems use structured intents and entity recognition to handle slightly more dynamic queries, but often lack the ability to connect with real-time backend systems, making them only marginally more intelligent. Both types are constrained by hard-coded logic and are unable to generalize across new use cases without significant reprogramming.

A further challenge lies in real-time data processing and tool integration. Current chatbots are often informational only, wherein they can retrieve data but cannot act on it. They are typically not configured to support end-to-end operational tasks such as changing item availability, launching campaigns, or adjusting prices. When such actions are needed, users is required to manually access external platforms such as point-of-sale (POS) systems, marketing dashboards, or analytics portals. This breaks the conversational workflow, increases cognitive load, introduces inefficiencies, and creates opportunities for human error.

The existing systems also lack personalization. They rarely factor in contextual data such as the user's role (e.g., manager vs. cashier), prior interaction history, current operational metrics, or business performance indicators. This results in generic and repetitive interactions that do not adapt to the user's business context, preferences, or behavior. Without personalized insights or recommendations, user engagement tends to decline, especially in high-frequency, high-intensity operational settings.

Scalability and modularity represent additional technical shortcomings. Many chatbot platforms follow monolithic architectures with tightly coupled components, making them difficult to maintain, extend, or configure. Adding a new domain, such as customer feedback analysis or delivery performance monitoring, often requires significant backend changes and manual adjustments to existing logic trees. Furthermore, these systems often lack centralized mechanisms to manage shared tools, prompts, and access control across multiple business domains.

Finally, most chatbot systems are configured to operate in a purely reactive fashion. They wait for the user to initiate a query and provide responses accordingly. They are not configured to proactively reach out to users with nudges, insights, or suggestions based on business conditions or behavioral triggers. For example, they cannot notify a merchant that a popular menu item is out of stock or suggest launching a discount campaign based on declining sales trends. This lack of proactive engagement limits the system's ability to drive user behavior or enhance business outcomes.

Accordingly, there is a need for an improved chatbot system that overcomes these limitations by offering multi-domain adaptability, real-time tool integration, proactive user engagement, and personalized interactions, all within a scalable, modular framework capable of streamlining complex business workflows.

### SUMMARY OF THE INVENTION

An embodiment provides a chatbot system and computer-implemented method configured to receive a user query and provide an intelligent, context-aware response across multiple business functions. The system is configured with a modular and scalable architecture, designed specifically to assist merchants by delivering real-time insights, enabling controlled automation of operational tasks, and proactively engaging users through intelligent messaging. Unlike traditional chatbots that rely on static templates or limited keyword matching, the disclosed system is configured to integrate domain-aware processing, dynamic tool invocation, and contextual memory tracking to streamline merchant workflows and support efficient decision-making.

The chatbot system is configured to employ a structured architecture that comprises a domain detection unit, a global configuration layer, domain-specific processing modules, a centralized tool unit, and a contextual memory module. Incoming queries are dynamically analyzed using user-specific contextual parameters (such as user ID, role, and permissions), enabling the system to identify the relevant business domain (e.g., sales performance, campaign evaluation, menu management). The query is then routed to a domain-specific module, each acting as an autonomous agent capable of invoking appropriate tools from a centralized repository.

Each domain module is configured to access one or more tools from a centralized tool store, which supports many-to-many mapping between tools and domains. Tools are categorized as either data retrieval tool 120s, which provide real-time access to structured business data (such as POS databases, inventory systems, or campaign analytics), or action-triggering tool 122s, which generate system instructions requiring user confirmation prior to backend execution. Results from these tools are compiled into action cards, interactive UI elements that present proposed actions to users with options to confirm, modify, or cancel.

The system's global configuration unit is configured to define key behavioral parameters across all domain modules, including response tone, formatting rules, role definitions, and compliance guardrails. This ensures that all user interactions, whether they involve sales analysis, item updates, or performance monitoring, are consistent, policy-aligned, and brand-compliant.

In addition to handling user-initiated queries, the system is configured to support proactive engagement through chitchat mechanisms and push-based recommendations. These features allow the chatbot to autonomously engage users based on real-time business context, for example, by recommending promotional campaigns during low-sales periods or alerting users to stock shortages.

The system is configured to achieve personalization through dynamic data integration and contextual memory. The system is configured to track both session-based and historical interactions to tailor its responses, preserve context, and minimize redundant queries. This enables the chatbot to deliver relevant and progressively refined outputs, aligned with each merchant's operational needs and historical behavior.

By integrating core components such as domain detection, prompt layering, centralized tool invocation, contextual memory, and proactive engagement, the disclosed chatbot system significantly improves operational efficiency, reduces manual effort, and delivers a superior user experience. It supports role-based access control, merchant-specific configurations, and rapid extensibility for future domain and tool integration—making it a robust and scalable solution for modern business environments.

### BRIEF DESCRIPTION OF DRAWINGS

Embodiments are illustrated by way of example and not limitation in the figures of the accompanying drawings, in which like references indicate similar elements and in which:

FIG. 1 illustrates a block diagram of system architecture of a chatbot system 100, in accordance with an embodiment;

FIG. 2 illustrates a flowchart 200 of a method for facilitating an adaptive multi-domain chatbot interaction, in accordance with an embodiment;

FIG. 3 illustrates a schematic block diagram of a conversation flow 300 between a user and the chatbot system 100, in accordance with an embodiment;

FIG. 4 illustrates a schematic view of an implementation 400 of the chatbot system 100, in accordance with an embodiment;

FIG. 5 illustrates an architectural diagram of a recommendation module 500 within the chatbot system 100, in an exemplary embodiment; and

FIG. 6 illustrates an exemplary computing environment on which an embodiment described herein may be implemented, in accordance with an embodiment.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practiced without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

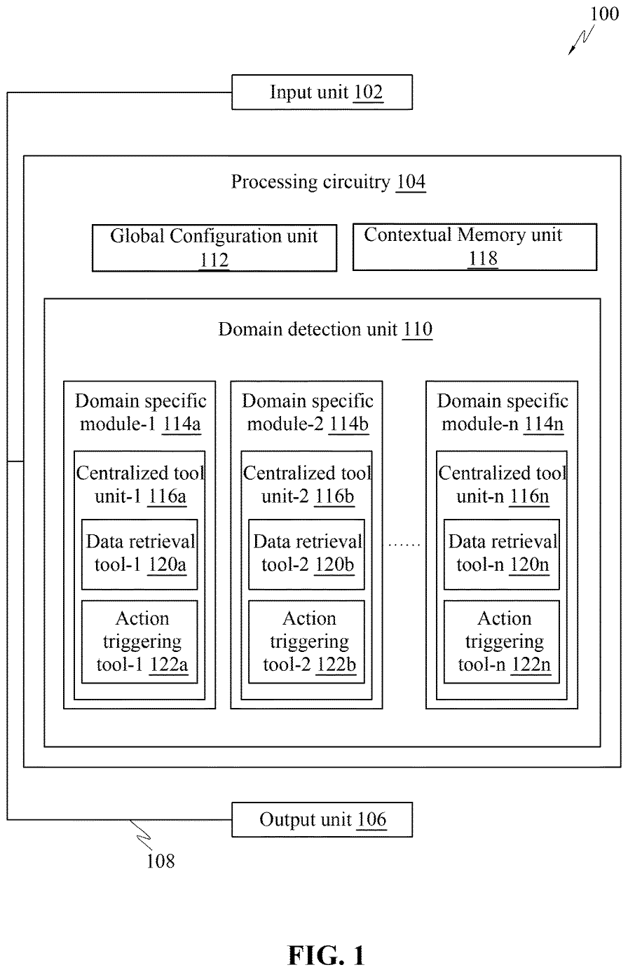

Referring to FIG. 1, a block diagram of system architecture of a chatbot system 100 is illustrated. The chatbot system 100 is configured to enable intelligent, multi-domain, context-aware user interactions by leveraging large language models (LLMs), dynamic tool invocation, and role-based modular architecture. The system may be particularly suited for applications involving merchant operations across sales, menu management, campaign analysis, and business intelligence functions.

In an embodiment, the system 100 comprises at least an Input Unit 102, a Processing Circuitry 104, a Contextual Memory Unit 118, and an Output Unit 106. The processing circuitry 104 further comprises of a Domain Detection Unit 110, a Global Configuration Unit 112, one or more Domain-Specific Modules 114, one or more Centralized Tool Units 116 and a Contextual Memory Unit 118. A Communication Channel 108 is provided configured for interconnecting all system components for enabling establishing communication between the interconnecting components.

In an embodiment, the input unit 102 may comprise one or more hardware and software components configured to facilitate user interaction with the chatbot system 100. The input unit may include, but is not limited to, keyboards, physical or virtual keypads, touchscreens, microphones, video cameras, barcode scanners, voice assistant interfaces, wearable sensors, and graphical user interface (GUI) elements. It may also include application programming interfaces (APIs), SMS gateways, social media messaging platforms, and IoT-connected input devices.

In retail and commercial implementations, the input unit may be integrated with merchant-specific systems, such as point-of-sale (POS) terminals, kiosk interfaces, and inventory control systems. Additionally, the input unit may interface with environmental sensors, biometric authentication systems, and geofencing modules to enable context-aware interaction. In some embodiments, it may also support real-time audio or video streaming, with integrated buffering and decoding logic to process continuous input.

The input unit may further support multilingual interactions, speech-based accessibility tools, and gesture-driven input modalities, enhancing usability across a diverse user base. The input data, once captured, is transmitted over a communication interface to the processing circuitry 104 for semantic analysis and routing.

In an embodiment, the input unit 102 is configured to receive one or more user queries directed to the chatbot system 100. The input unit 102 is configured to support multi-modal input, allowing users to interact with the system 100 through text, audio, and/or video-based queries. The ability to accept inputs in different formats enables broader accessibility and seamless integration across various platforms, including web-based dashboards, mobile applications, voice-enabled kiosks, and third-party messaging interfaces.

In text-based interactions, the input unit 102 may be configured to accept queries via chat interfaces, command-line prompts, or embedded widgets. In audio-based embodiments, the input unit 102 may be configured to include or interface with different speech recognition modules that convert spoken language into structured text using natural language processing (NLP) engines. Similarly, for video inputs, such as those captured through customer service booths or smart devices, the input unit 102 may be configured to incorporate speech-to-text pipelines or gesture recognition subsystems to extract actionable content from video streams.

Once received, the input may be optionally preprocessed to standardize its format for further downstream processing. This may include operations such as tokenization, language normalization, intent tagging, and entity recognition. These preprocessing steps help ensure the downstream domain detection unit 110 receives semantically consistent input for accurate classification and routing.

In some embodiments, the input unit 102 may be configured to also associate user metadata with each query. Such metadata may include a user identifier, session token, device information, timestamp, or geolocation, which are forwarded to the processing circuitry 104 for personalized, context-aware interpretation.

The design of the input unit 102 emphasizes extensibility, allowing integration with third-party input sources such as customer messaging platforms or voice assistants. The input unit 102 may also include input filtering logic to reject unsupported formats or flag potentially harmful content, ensuring that the system 100 operates securely and within expected parameters.

In an embodiment, the processing circuitry 104 is configured to perform one or more computational operations necessary for implementing context-aware interpretation of user input, determining applicable business logic, invoking relevant computational tools, generating structured responses, and preserving conversational continuity across interactions. The processing circuitry 104 is operatively coupled to both the input unit 102 and the output unit 106 and is configured for executing the core logical and computational processes of the chatbot system.

The processing circuitry 104 may include one or more hardware processors, such as central processing units (CPUs), graphics processing units (GPUs), digital signal processors (DSPs), or system-on-chip (SoC) devices. In some implementations, the processing circuitry 104 may be deployed in a distributed configuration utilizing cloud-hosted infrastructure, local edge computing environments, or a hybrid of both, depending on system requirements. The processing circuitry 104 may be communicatively coupled to other system components via secure communication interfaces and may operate in a synchronous or asynchronous manner relative to input and output operations.

The processing circuitry 104 may comprise of plurality of subsystems like, but not limited to, domain detection unit 110, global configuration unit 112, one or more domain-specific processing modules 114 (114A, 114B . . . 114n), one or more centralized tool unit 116 (116a, 116b . . . 116n) each associated with respective domain-specific processing modules 114, and contextual memory unit 118. Each subsystem is configured to be functionally distinct to support specific aspects of multi-domain query handling and response generation.

In an embodiment, the domain detection unit 110 is configured to determine the most appropriate functional domain for a given user query by evaluating a set of user-specific and contextual parameters. These parameters may include a user identifier, assigned role, permission level, prior interaction history, and inferred query intent. Based on this evaluation, the domain detection unit 110 may be configured to route the query to a corresponding domain-specific processing modules 114 for further analysis and response generation.

In an embodiment, the global configuration unit 112 is configured to apply system-wide parameters that define the operational characteristics of the chatbot system 100. These parameters may include tone specifications, output formatting rules, persona and branding definitions, policy constraints, and consistency metrics. The global configuration unit 112 is configured to ensure that outputs generated across various business domains adhere to predefined standards and regulatory requirements. Each domain-specific module may be an autonomous processing component configured to manage a particular category of business operations, such as sales analytics, inventory control, promotional campaign optimization, or menu configuration. These modules may be independently instantiated and may be configured to invoke computational tools from the centralized tool unit 116 to retrieve data or generate executable actions related to backend systems.

In an embodiment, the centralized tool unit 116 comprises a repository of reusable, callable tools that may be accessible to all domain-specific modules. The tools may comprise at least one of data retrieval tool 120 configured to interact with point-of-sale (POS) systems, order tracking platforms, and analytics engines, and action-triggering tool 122 that generate executable instructions for updating backend services. In certain embodiments, the centralized tool unit 116 may be configured to generate action cards that encapsulate proposed operations, which are then rendered to the user for review, approval, or modification via the output unit 106.

In an embodiment, the system 100 comprises of one or more data retrieval tools 120 (120a, 120b . . . 120n) and one or more action triggering tools 122 (122a, 122b . . . 122n), each of them associated with respective centralized tool unit 116 (116a, 116b . . . 116n) which in turn may be associated with respective domain specific modules 114 (114a, 114b . . . 114n).

In an embodiment, the contextual memory unit 118 is configured to store and manage conversational state and historical interaction data. This may include short-term session memory, long-term behavioral profiles, and context-specific metadata that inform subsequent interactions. By maintaining and updating these memory structures, the system can deliver contextually relevant and personalized responses across user sessions. The contextual memory unit 118 is configured to store and manage conversational state and historical interaction data. This may include short-term session memory, long-term behavioral profiles, and context-specific metadata that inform subsequent interactions. By maintaining and updating these memory structures, the system can deliver contextually relevant and personalized responses across user sessions.

In an embodiment, the domain detection unit 110 is configured to identify the appropriate business domain for handling the user query, enabling accurate and context-aware task execution across the chatbot system 100. The term “business domain” in this context refers to discrete functional areas such as inventory control, menu management, sales performance analysis, or campaign evaluation. By determining the correct domain, the system 100 ensures that each query is interpreted and processed using the logic, data, and tools most relevant to the operational context.

The domain detection process may incorporate both user-specific and contextual data. This includes attributes such as a user identifier, which may uniquely distinguish each user within the system 100, and a role designation, which may reflect the user's function within the organization and governs access permissions to various business modules. The domain detection unit 110 may be configured to retrieve this information from session metadata or from a persistent user profile, and utilize it to narrow the scope of eligible domains for further consideration. In addition to user metadata, the domain detection unit 110 may be configured to evaluate the semantic content of the query, drawing upon natural language processing techniques to assess intent and extract entities relevant to domain classification.

In an embodiment, the domain detection unit 110 may be configured to support dynamic prompt generation, wherein upon identifying the probable relevant domain, the system 100 may be configured to construct a domain-specific prompt integrating contextual values, such as merchant identifiers, time ranges, or item references. This prompt may be generated using modular logic templates tailored to each domain, and may serve to clarify the user's intent or to structure subsequent interactions with a language model or domain-specific module.

Once the relevant domain is identified, the domain detection unit may be configured to route the query and its associated metadata to corresponding domain-specific module 114. This routing process may be executed in accordance with system configuration rules and role-based access controls. For example, if the user's role does not authorize access to the identified domain, the system 100 may return a restricted access message or invoke an alternate workflow. The routing logic may also include fallback procedures for low-confidence classifications, enabling the system 100 to defer to a generic handler or request clarification from the user.

The output of the domain detection unit 110 may comprise a structured set of parameters including the selected domain, the user context, and any generated domain-specific prompts. This information may be transmitted to the domain-specific module 114, which may use it as the basis for executing relevant tasks and generating a response.

In an embodiment, the system 100 comprises plurality of domain-specific modules 114, each configured to manage computational tasks and data processing operations associated with a particular business domain. These domains may comprise, for example, sales analysis, inventory management, promotional campaign evaluation, or menu configuration. Each domain-specific module 114 may be implemented as an autonomous processing unit having internal logic, domain-specific configuration rules, and access to associated tools. Each domain-specific module 114 may be communicatively coupled to both the domain detection unit 110 and the centralized tool unit 116. The domain-specific module 114 is configured to receive queries routed from the domain detection unit 110 along with contextual metadata, such as user identifiers, permission attributes, and session-specific data. The domain-specific module 114 is further configured to select or generate structured prompts/domain-specific prompts using modular logic rules defined for its respective domain. These prompts may be used to interface with downstream models or tools in the system 100.

In an embodiment, each domain-specific module 114 is further configured to access tools within the centralized tool unit 116. These tools may include data retrieval tool 120s for accessing structured business data, as well as action-triggering tool 122s for constructing system commands or updates. The selection of a particular tool may be determined based on internal rule sets within the domain-specific module 114 that interpret query content and context.

In an embodiment, the domain-specific module 114 may be configured to invoke one or more tools from the centralized tool unit 116, depending on whether the query requires data retrieval or action execution. In cases where a task requires backend system interaction, the domain-specific module 114 identifies the appropriate action-triggering tool 122, but does not itself construct the action card. Instead, this responsibility is delegated to the tool unit. The module acts as a logical intermediary by preparing and transmitting input parameters and by processing outputs returned from the tool, including action cards, which are subsequently forwarded to the output unit 106 for presentation to the user.

The domain-specific modules 114 may also produce structured outputs such as natural language responses or formatted data views. These outputs may be generated using internal rendering logic that conforms to system-wide configuration policies. In cases where the tool output includes an action card, the module is responsible for ensuring that the card is passed to the output unit 106, where it can be reviewed, confirmed, or modified by the user prior to final execution. Each domain-specific module 114 includes embedded access control logic to enforce role-based usage policies. Access to tools, features, or data is filtered based on the user's role, which is determined by session context or retrieved identity attributes. This selective access ensures operational security, regulatory compliance, and functional relevance for each user interaction.

The modular architecture of the domain-specific modules 114 allows for extensibility and scalability across business functions. New modules can be integrated into the system 100 by associating them with a functional domain, registering their interface parameters with the domain detection unit 110, and defining permissible tool bindings within the centralized tool unit 116. This model supports rapid deployment of new capabilities without necessitating significant reconfiguration of existing components.

In an embodiment, the contextual memory unit 118 is configured to preserve conversation history and maintain contextual relevance across user interactions. The contextual memory unit 118 enables the chatbot system 100 to sustain session continuity and personalize interactions over both short-term and long-term engagement windows. The contextual memory unit 118 serves as a persistent memory layer that tracks conversational state and user behavior across multiple sessions.

The contextual memory unit 118 may be configured to maintain a hierarchical memory model that includes session-based memory, historical usage profiles, and domain-specific interaction traces. Session memory allows the system 100 to maintain coherence within ongoing conversations by referencing prior user inputs, identifying omitted parameters, and preserving discourse structure. This capability supports multi-turn dialogues, clarification prompts, and continuity across task flows.

In parallel, the long-term memory layer may be configured to store behavioral summaries that include interaction frequencies, preferred domains, query types, and tool usage trends. These summaries may be dynamically updated and used to tailor system behavior to the individual user, enabling personalization of prompts, responses, and tool recommendations.

In an embodiment, the contextual memory unit 118 may be operatively linked to the domain detection unit 110, domain-specific modules 114, and the output unit 106. During domain detection, contextual memory may be referenced to refine classification accuracy or suggest domain-specific prompts. Similarly, domain modules 114 can leverage stored context to auto-complete or narrow tool invocation logic. Outputs may also be formatted or prioritized based on previously stored preferences.

In an embodiment, the contextual memory unit 118 may comprise predetermined logic for memory management, including rules for data retention, expiration, and access control. Memory contents may be selectively retained, purged, or anonymized in accordance with data privacy policies and system configurations. Access to specific context data may also be limited by user role or domain-level permissions. By preserving conversation history and adapting to the behavioral context of each user, the contextual memory unit 118 is configured to enhance the system's ability to deliver relevant, efficient, and personalized interactions.

In an embodiment, the global configuration unit 112, also referred to as a global prompt layer, which is a centralized subsystem that may be configured to define the interaction behavior of the chatbot system 100 across all business domains. The global configuration unit 112 is configured to establish and enforce a uniform set of parameters that govern how the system 100 formulates responses, applies tone and formatting standards, manages role-based interaction rules, and adheres to compliance and policy requirements.

The global configuration unit 112 may include configuration data specifying system-wide interaction parameters. These may comprise tone guidelines that determine the linguistic character of system responses (e.g., formal, friendly, concise), formatting rules for structuring outputs (e.g., list-based summaries, paragraph narratives, tables), persona attributes that define the chatbot's operational voice and style, and compliance guardrails that enforce limitations on sensitive data exposure, disclaimers, or mandatory response structure. In an embodiment, the global configuration unit 112 may also define success metrics or performance criteria used to guide or evaluate system responses.

The global configuration unit 112 may be communicatively coupled to the domain detection unit 110, the domain-specific modules 114, and the output unit 106, and provides each with the relevant global configuration data during runtime. The domain-specific modules reference these settings during query interpretation, prompt generation, and tool selection, ensuring that responses remain aligned with system-wide interaction principles and enterprise branding requirements.

In an embodiment, the global configuration unit 112 supports dynamic rule evaluation based on user roles, business context, or merchant-specific preferences. For example, executive-level users may receive responses that are more data-rich or strategically oriented, while frontline staff may be presented with simplified task summaries. Additionally, the system may apply stricter formatting or policy rules in domains subject to industry-specific regulations.

The global configuration unit 112 may further operate as a policy enforcement layer. It may be configured to perform runtime validation checks, redaction operations, or pre-response audits to ensure outputs comply with legal, regulatory, or contractual requirements. These validation mechanisms are applicable across all domains, making the unit essential for enterprise-scale governance. By standardizing interaction behavior and output generation across all chatbot modules, the global configuration unit 112 ensures consistent, brand-aligned, and policy-compliant system performance. It simplifies maintenance, supports scalability across domains, and reinforces operational coherence across varied use cases and deployment environments.

In an embodiment, the output unit 106 is configured to present the system-generated content to the end user in a structured, coherent, and contextually appropriate manner. The output unit 106 may be configured to function as the final delivery layer of the chatbot system and is responsible for rendering various types of responses, insights, and interactive artifacts, including action cards. The output unit 106 facilitates communication between the system's internal processing components and the user-facing interface.

The output unit 106 may comprise of one or more hardware and software components configured to support diverse user interface modalities. These may include graphical user interface (GUI) rendering engines, display drivers, speech synthesis modules, web output services, or platform-specific rendering frameworks. The output unit 106 may be integrated with various types of display hardware such as touchscreens, desktop monitors, mobile device displays, kiosk terminals, or embedded system panels. The output unit 106 may also support voice-based responses through audio output interfaces connected to speakers or headset systems.

The output unit 106 may be configured to render multiple categories of content. This includes plain-text responses, structured insights such as tables or charts, and interactive components such as action cards. Action cards may be generated by the Tool Unit and transmitted to the output unit 106 for presentation. Each card includes operational details along with embedded interface elements that allow users to approve, reject, or modify the proposed action before backend execution. The output unit 106 may also support drag-and-drop, tap-to-confirm, or gesture-based inputs associated with action elements.

In an embodiment, the communication channel 108 is configured to enable structured data exchange between the various subsystems of the chatbot system 100 comprising the input unit 102, processing circuitry 104, output unit 106, and all internal components thereof, such as the domain detection unit 110, domain-specific modules 114, centralized tool unit 116, contextual memory unit 118, and global configuration unit 112.

The communication channel 108 may comprise hardware and software components designed to support inter-component communication. These components may include high-speed data buses, shared memory interfaces, messaging queues, application-layer APIs, or service communication protocols such as HTTP, gRPC, or WebSockets. The design of the communication channel 108 may vary depending on system deployment architecture and may support centralized or distributed configurations. The communication channel 108 may be configured to handle both synchronous and asynchronous data transfer, supporting real-time interactions where required and deferred or batched communication for background operations. Communication may be event-driven or request-response-based, depending on the operational context of the interacting subsystems. Transmission protocols may include provisions for data integrity, authentication, and encryption to ensure secure and verifiable messaging between components.

In an embodiment, the communication channel 108 may be configured to enable message routing between the functional units of the system. For instance, incoming user query received by the input unit 102 may be transmitted to the processing circuitry 104, where it may be further routed to the domain detection unit 110 and onward to an appropriate domain-specific module 114. Similarly, action cards generated by the centralized tool unit 116 or formatted outputs from the global configuration unit 112 are delivered to the output unit 106 for user presentation.

In an embodiment, the chatbot system 100 may be configured to interface with one or more external client servers to retrieve operational data and perform backend task execution. These external client servers may be operated by merchants, business partners, or third-party platforms, and may include integrated systems such as point-of-sale (POS) databases, order management systems, inventory platforms, or analytics engines. The external client servers may expose data or services that are accessed through defined interfaces by the chatbot system 100. Communication between the chatbot system 100 and the external client servers may be established through an external communication network. The external communication network may be wired or wireless connections and may include public or private networks such as the internet, virtual private networks (VPNs), cloud interconnects, or dedicated enterprise backbones. Data may be transmitted over this network using secure, authenticated protocols such as HTTPS, TLS-encrypted REST APIs, WebSockets, or message-broker architectures.

In an embodiment, the centralized tool unit 116 may be configured to invoke external APIs or service endpoints exposed by the external client servers via the external communication network. For instance, when a user submits a query requiring real-time sales data, the relevant data retrieval tool 120 may be configured to construct a request that may be transmitted over the network to the appropriate integrated system, receives the response, and returns the structured output to a domain-specific module 114 for processing.

The external communication network may also support event-driven communication models, enabling the chatbot system to receive real-time notifications, webhook events, or push updates from external client servers, which may facilitate proactive engagement, task automation, and contextual response generation based on changes in merchant-side system state. The combination of the external communication network and the system's modular client integration layer allows the chatbot system 100 to operate effectively across a diverse ecosystem of external platforms.

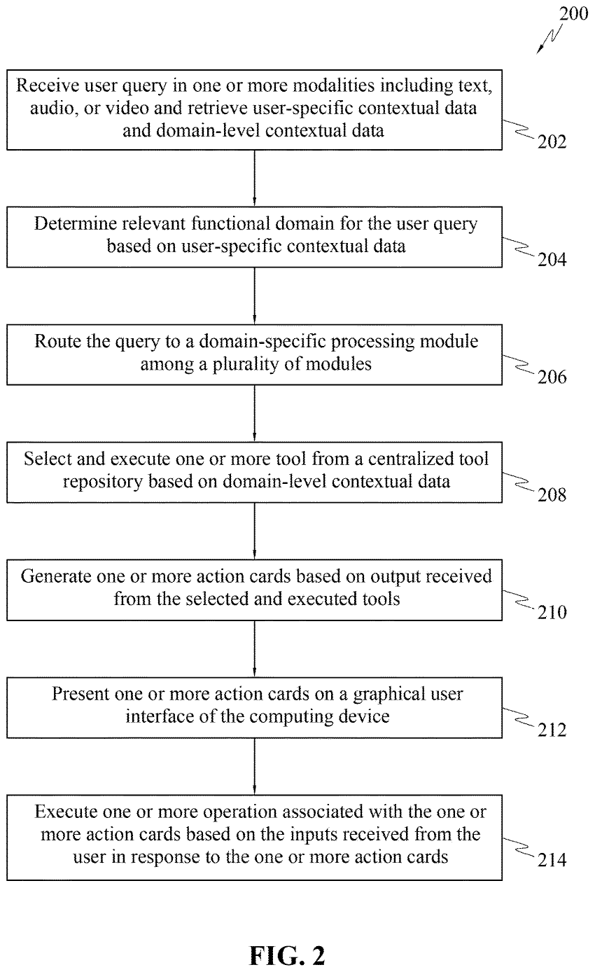

FIG. 2 illustrates a method 200 for facilitating an adaptive multi-domain chatbot interaction in accordance with an embodiment.

At step 202, a user query is received by the input unit 102 of the chatbot system 100. The input unit 102 is configured to support multimodal user interaction and is operable to receive input in one or more modalities, including text, audio, or video. The system 100 is also configured to retrieve user-specific contextual data and domain-level contextual data. This enables the chatbot system 100 to operate across a range of access interfaces, such as web-based dashboards, mobile applications, voice-activated terminals, and embedded kiosk systems.

In an embodiment, the user may input the query in text format via a graphical user interface (GUI). For example, a store manager may type a query such as, “Show me the best-selling drinks this month” into a chat interface on a desktop dashboard. The input unit 102 may be configured to capture the text and convert it into a structured format suitable for downstream processing by the processing circuitry 104.

In an embodiment, the input unit 102 may receive audio input through a microphone or voice-enabled device. The chatbot system 100 may include or interface with an automatic speech recognition (ASR) module to convert the spoken language into transcribed text. For instance, a user may state, “What's the current inventory for bottled water?” and the input unit 102, via the ASR component, generates the corresponding structured query for further analysis.

In an embodiment, the input unit 102 may include a camera or gesture recognition system configured to capture video input. For example, a user interacting with a smart point-of-sale (POS) terminal may trigger a predefined gesture indicating a restocking request. The gesture recognition subsystem may interpret this input as a predefined command equivalent to a textual query such as, “Restock beverage inventory.”

Alongside the content of the query, the input unit 102 may also be configured to capture or associate one or more contextual metadata elements that characterize the user and their environment at the time of query submission. Such metadata may include, but is not limited to, a user identifier (e.g., usr_02345 or a user email address), a session identifier (e.g., sess_00981) for stateful interaction, a device type (e.g., desktop_browser, mobile_app, or kiosk_terminal), a timestamp indicating when the query was received (e.g., 2025-May-23T14:42:11Z), a merchant identifier or store ID (e.g., store_0456), optional geolocation coordinates (e.g., 37.7749° N, 122.4194° W), and language or localization preferences (e.g., en-US).

In an embodiment, the user-specific contextual data may include one or more of: the user's role designation (e.g., “manager,” “owner”), user identifier, merchant ID, active permissions, prior query history, and current session metadata.

In an embodiment, the domain-level contextual data may include one or more of the following: a domain identifier, a merchant identifier, one or more product or service categories extracted from the user query, a time frame or reporting period, a user role designation, and a set of permissions linked to the user's access level.

These metadata parameters may be transmitted along with the query to the processing circuitry 104, where they are used to support domain identification, personalization, role-based access control, and consistent formatting of system responses.

At step 204, the chatbot system 100 determines, by the processing circuitry 104, a relevant functional domain for the received user query based at least in part on user-specific contextual data. This operation is performed by the domain detection unit 110, which is configured to analyze the query content in conjunction with contextual parameters extracted in prior steps.

The user-specific contextual data may be used by the domain detection unit 110 to constrain and guide the domain selection process, ensuring that the system 100 identifies a business function the user is both authorized for and contextually aligned with.

The domain detection unit 110 may employ a combination of rule-based classifiers, keyword-matching logic, prompt templates, or machine learning models to infer the most applicable domain. In some embodiments, the domain detection unit 110 dynamically constructs a domain-specific prompt or feature vector that captures both the semantic content of the query and the operational context of the user.

For example, when a user identified as “user_001” with the role of “manager” and permissions including [“read_sales_data” and “initiate_promotions”] submits the query: “Why are burger sales down this week?”, the domain detection unit 110 identifies key tokens: “sales,” “burger,” “this week,” and combines this with role and permission data. Based on this analysis, the system 100 selects the Sales Analytics domain as the most relevant functional domain. The query is prepared for routing to the Sales Analytics Module, a domain-specific module 114 configured to support queries related to item-level sales performance.

This domain determination step ensures that the query is processed within the appropriate operational context, allowing subsequent modules to execute logic, access tools, and generate responses aligned with the user's responsibilities and business function.

At step 206, the chatbot system 100 is configured to route the user query, by the processing circuitry 104, to a selected domain-specific processing module 114 from among a plurality of such modules. Each domain-specific module 114 is an autonomous processing unit configured to perform operations related to a particular functional domain, such as sales analytics, inventory control, menu administration, or promotional campaign management.

The processing circuitry 104 references a domain-to-module routing map or registry to determine the target module corresponding to the identified domain. The system 100 then forwards the user's query, along with related context such as the user ID, store ID, role, and session details, to the selected domain-specific module for processing.

Prior to final routing, the processing circuitry 104 enforces role-based access control. If the user's role does not grant permission to access the selected domain, the system 100 may return a restricted-access message or reroute the query to a permitted fallback domain. Access policies are centrally managed by the global configuration unit 112 and may be updated per merchant-specific rules or system-wide compliance policies.

For example, when a store supervisor identified as “user_001” with the role “floor_supervisor” submits the voice command: “Restock bottled water and juice.”, the domain detection unit 110 classifies the query under the Inventory Management domain. The processing circuitry 104 then consults the routing registry and resolves this to the Inventory Module, a domain-specific module 114 configured to manage item-level stock operations. The payload is then passed to the Inventory Module via an internal function call.

At step 208, the chatbot system 100, via the processing circuitry 104, is configured to select and execute, based on domain-level contextual data, one or more tools from the centralized tool unit 116. Each tool is callable by respective domain-specific module 114 and is configured to process data or initiate operations related to the specific functional domain to which the query has been routed.

In an embodiment, the domain-level contextual data may be used by the domain-specific module 114 to select appropriate tools that are configured to operate on domain-relevant data and return structured outputs or proposed actions.

The domain-specific module 114 may be configured to invoke tools that are mapped to the currently active domain. These tools may include data retrieval tools 120, configured to access structured business data from integrated systems (e.g., point-of-sale databases, inventory systems, campaign performance metrics), and action-triggering tools 122, configured to construct proposed operational changes (e.g., price updates, availability toggles) and return them in an interface-ready format.

Tool selection may be based on domain-level contextual data, which may include parameters such as the domain identifier, the merchant ID, item category, user role, prior tool usage, and operational context extracted from the query itself. Once selected, the tool may be executed by the system 100 to obtain real-time outputs, such as analytics summaries or proposed changes to backend configurations.

For example, if the user query is: “Why are burger sales down this week?, and has been routed to a domain-specific module 114 corresponding to the Sales Analytics domain, the following domain-level contextual data may be derived: Domain Identifier: “sales_analytics”, Merchant ID: “store_0456”, Item Category: “burgers”, Time Frame: “current_week vs previous_week”, User Role: “manager”, Access Rights: [“view_sales_data”, “view_trends”]. Based on these parameters, the domain-specific module 114 may select one or more tools from the centralized tool unit 116, such as: A Sales Trend Comparison Tool, configured to retrieve and compare weekly sales metrics for the selected item category, and A Category Performance Summary Tool, configured to return sales comparisons between the queried category and other major item categories.

The selected tools are executed by the system 100 using the provided contextual parameters, and the resulting data is returned to the domain-specific module 114 for downstream processing, such as action card generation and response formatting.

In some embodiments, the centralized tool unit 116 supports both data retrieval tool 120s and action-triggering tool 122s. Data retrieval tool 120s are configured to access structured business data from integrated backend systems (e.g., point-of-sale databases, analytics engines), while action-triggering tool 122s are configured to construct executable operations, such as status updates or pricing changes, subject to user confirmation.

At step 210, the chatbot system 100 is configured to generate, by the processing circuitry 104, one or more action cards based on output received from the previously executed tools within the domain-specific module 114. Each action card is a structured, interface-ready artifact that includes proposed operations, recommendations, or system-generated insights, along with interface elements configured to enable user interaction.

The action card may be constructed by the domain-specific module 114 using the tool output and any additional domain-relevant data fields derived from the user query, contextual parameters, and session state. Each action card may include, for example: a textual summary of the proposed task, one or more user-selectable options (e.g., approve, modify, cancel), relevant identifiers such as item IDs, campaign codes, or schedule references, and embedded metadata for traceability, compliance, or backend execution. In an embodiment, action cards may be categorized as either informational (e.g., presenting trend data, performance alerts) or action-triggering, in which case they propose a concrete change that may be executed by the system upon user confirmation.

For example, following the execution of the Sales Trend Comparison Tool, the domain-specific module 114 which may be referred to as Sales Analytics Module determines that burger sales have declined by 12% compared to the previous week. Based on predefined business rules, the module 114 constructs an action card proposing a promotional campaign. The generated action card may include: Title: “Sales Decline Detected: Burgers”, Summary: “Burger sales are down 12% this week. Would you like to offer a 10% weekend discount to boost demand?”, Data Fields like, Item: “burgers”, Discount: “10%”, Validity: “Saturday-Sunday”, Store ID: “store_0456”, Action Options: “[Approve], [Edit], [Cancel]”.

The action card may be formatted in a consistent layout as specified by the global configuration unit 112 and is made available to the output unit 106 for user-facing presentation in the next step.

In an embodiment, multiple action cards may be generated from a single query, especially where the tool output includes comparative options, alternative actions, or escalation recommendations. Each card may be assigned a unique identifier and logged by the system for traceability and audit purposes.

At step 212, the chatbot system 100 is configured to present, via the output unit 106, one or more action cards to the user on a graphical user interface (GUI) of the computing device. The output unit 106 may be responsible for rendering the action cards in a format that supports interactive user engagement, consistent with system-wide behavioral and formatting parameters defined by the global configuration unit 112.

The presentation of the action cards may include visual elements such as buttons, dropdown menus, sliders, or input fields embedded within the GUI, allowing the user to review proposed tasks, modify parameters, approve, or cancel operations. The output unit 106 formats these elements according to role-based display policies and accessibility guidelines to ensure clarity and ease of use.

In an embodiment, the output unit 106 supports multiple interface platforms including web browsers, mobile applications, voice assistants with visual display capabilities, and integrated point-of-sale terminals.

For example, continuing from the previous step, the action card proposing a 10% weekend discount for burgers is displayed on the manager's mobile app interface. The card includes: a clearly labeled title and summary of the promotion, Interactive buttons labeled [Approve], [Edit], and [Cancel], and editable fields for discount percentage and valid dates if the user selects [Edit].

Upon viewing, the user can interact with the card to confirm or modify the proposed campaign. The output unit 106 captures user inputs and relays them back to the processing circuitry 104 for subsequent action execution.

The output unit 106 may also log user interactions with the action cards for audit and analytics purposes, providing insight into user behavior and system effectiveness.

At step 214, the chatbot system 100 is configured to execute, by the processing circuitry 104, one or more operations associated with the action cards based on inputs received from the user in response to the presented action cards. The processing circuitry 104 receives the user's selections or modifications from the output unit 106 and processes these inputs to initiate corresponding backend tasks.

In an embodiment, execution of backend operations may involve invoking action-triggering tool 122s from the centralized tool unit 116. These tools generate executable instructions or signals to effectuate changes in integrated business systems, such as updating menu item availability, adjusting pricing, launching promotional campaigns, or modifying inventory records.

The system ensures that all backend operations conform to applicable access controls, role-based permissions, and compliance rules as enforced by the global configuration unit 112. Operations are only executed after explicit user approval or confirmation, thereby maintaining oversight and preventing unintended changes.

Upon successful execution, the processing circuitry 104 may generate confirmation messages or updated status reports, which are sent back to the output unit 106 for presentation to the user. In case of execution failure, error messages or alternative options may be provided for corrective action.

For example, following approval of the 10% discount action card, the processing circuitry 104 invokes an action-triggering tool 122 within the centralized tool unit 116 to activate the promotional campaign for burgers at store “store_0456”. The tool constructs and transmits backend instructions to the merchant's campaign management system, scheduling the discount for the specified weekend dates.

The system 100 may be then configured to provide confirmation feedback to the user: “Promotional campaign for burgers with 10% discount has been successfully scheduled for this weekend.”. If the activation fails due to system errors or permission issues, the user may be notified and presented with options to retry or modify the campaign.

In an embodiment, the global configuration unit 112 plays a critical role throughout the chatbot system's operation by enforcing system-wide behavioral policies and configuration parameters across all functional domains. The global configuration unit 112 defines interaction behavior aspects such as response tone, formatting standards, compliance guardrails, and role-based access policies. During each step, from query reception through domain detection, tool execution, action card generation, and backend operation execution, the global configuration unit 112 ensures consistent adherence to brand guidelines and regulatory requirements. It also governs access control by validating user roles and permissions, thereby preventing unauthorized access or actions within domain-specific modules.

In an embodiment, the contextual memory unit 118 is configured to maintain conversational continuity and personalization by storing multi-level contextual data, including session-based interaction history and long-term behavioral profiles. This unit supplies relevant context to the domain detection unit 110 and domain-specific modules 114 to enhance query interpretation and tool selection. It also retains user responses to action cards and tracks system interactions over time, enabling progressive refinement of responses and proactive engagement. By preserving context across multiple user interactions, the contextual memory unit 118 supports a coherent, efficient, and personalized user experience throughout the chatbot's workflow.

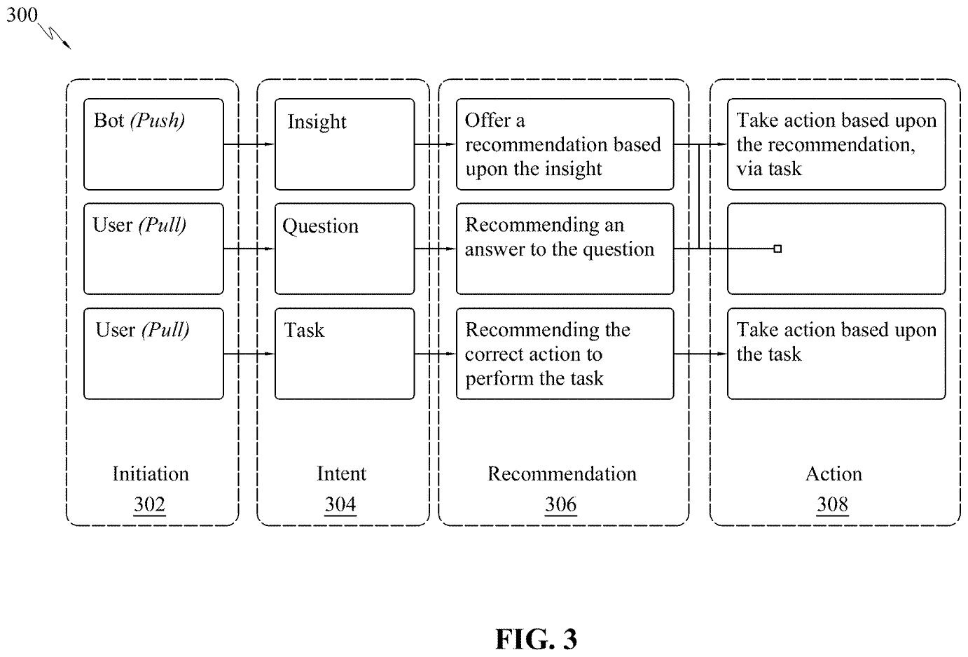

FIG. 3 illustrates a schematic block diagram of a conversation flow 300 between a user and the chatbot system 100, in accordance with an embodiment of the present disclosure. The conversation flow 300 comprises a sequence of executable blocks arranged in a predetermined order. The flow includes a pull-push block 302, an intent block 304, a recommendation block 306, and an action block 308. The pull-push block 302 initiates the conversation flow, followed sequentially by the intent block 304, then the recommendation block 306, and concluding with the action block 308.

The chatbot system 100 may be configured to support two primary modes of conversation initiation: user-initiated (pull) interactions and system-initiated (push) interactions. The pull-push block 302 facilitates these modes, enabling both reactive and proactive engagement strategies. This dual-mode approach enhances system usability, encourages frequent interactions, and improves operational efficiency by supporting both user requests and autonomous system recommendations.

In the user-initiated (pull) mode, the interaction begins when a user submits a query to the system 100. The system 100 is configured to analyze the intent of the received query and determine an appropriate response or action. For example, when a user requests creation of a new menu item, the system 100 processes this request and generates an action card containing relevant fields and options for the user to review and confirm prior to execution. This ensures that user intent is accurately captured and subsequent actions are performed with explicit user approval.

In the system-initiated (push) mode, the chatbot system 100 proactively initiates conversations with the user. These interactions may include casual chitchat to maintain user engagement or actionable recommendations derived from contextual business data. For example, the system 100 may detect that a high-demand item is out of stock and initiate a conversation suggesting restocking, accompanied by an action card to facilitate prompt execution. Integrating both conversation initiation modes enables seamless, context-aware interaction and promotes proactive operational management.

The intent block 304 may be responsible for interpreting the user's queries and system-initiated messages. The intent block 304 is configured to identify questions, understand requests, and complete tasks in response to user input. The recommendation block 306 is configured to provide suggestions based on system insights, recommend answers to questions or appropriate actions to perform tasks. The action block 308 is configured to execute operations based on these recommendations, implementing the tasks as authorized through user interaction or system protocols.

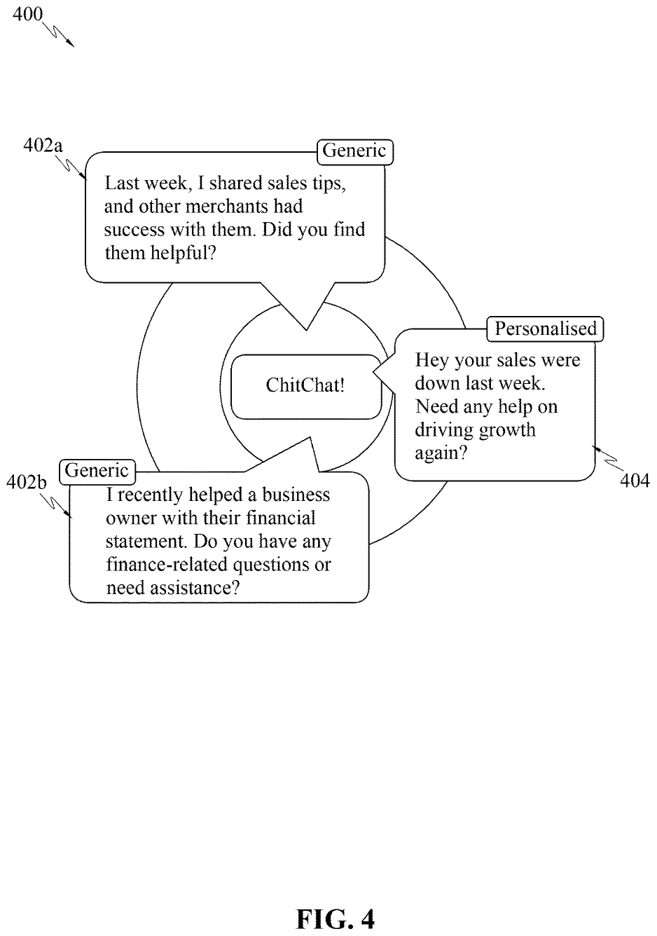

FIG. 4 illustrates a schematic view of an implementation 400 of the chatbot system 100, in accordance with an embodiment of the present disclosure. The implementation 400 depicts various types of conversational interactions supported by the system 100, including generic chats 402a, 402b and personalized chats 404, among others. These interactions encompass a broad range of chatbot-generated messaging designed to enhance user engagement and operational effectiveness.

The chatbot system 100 incorporates a chitchat engagement mechanism configured to proactively initiate conversational prompts that are not limited to direct transactional queries. The chitchat functionality enables the generation of diverse message types that vary in their level of personalization and contextual relevance.

The generic chats 402a, 402b may comprise predefined messages generated from static templates. These messages may be dispatched at predetermined intervals, such as daily or weekly, and typically include general business tips, motivational content, or reminders designed to maintain regular communication with the user and encourage ongoing system usage.

In contrast, the personalized chats 404 may be dynamically generated based on merchant-specific operational data and contextual business metrics. These messages may be tailored to the merchant's recent activity and performance. For example, the system 100 may detect high sales volume for a given period and initiate a supportive prompt such as, “Looks like you had a great sales day yesterday! Would you like tips on boosting engagement further?” This approach enhances relevance and fosters more meaningful interactions.

Additionally, the system 100 may integrate large language models (LLMs) to produce context-sensitive conversational outputs in real time. These LLM-generated chats adapt dynamically to evolving business conditions and user behavior, providing nuanced and natural language interactions that reflect ongoing merchant engagement.

The system 100 further supports retention chats, which are designed to re-engage merchants exhibiting signs of reduced activity or potential churn. By analyzing historical interaction patterns and conversation histories maintained within the contextual memory unit 118, the chatbot system 100 generates targeted messages aimed at reactivating user interest. For example, a retention message may state, “Hey [User Name], we haven't seen you in a while! Need help setting up a new promo to attract more customers?”

Through integration of these varied chitchat types, generic, personalized, LLM-generated, and retention-focused, the system 100 may be configured to implement a comprehensive proactive communication strategy. This strategy supports sustained user engagement, delivers contextual assistance, and enables business growth for merchants by maintaining an interactive and responsive conversational environment.

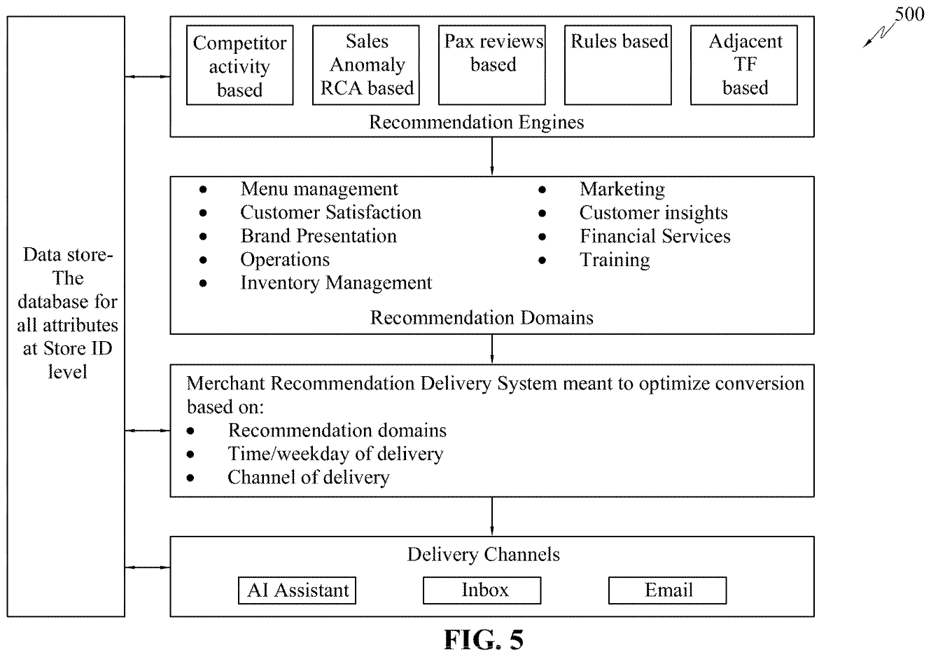

FIG. 5 illustrates an architectural diagram of a recommendation module 500 within the chatbot system 100, in an exemplary embodiment. The recommendation module 500 is configured to facilitate structured push recommendation functionality, which operates independently from the general chitchat mechanisms described previously.

In an embodiment, the recommendation module 500 comprises, but is not limited to, one or more recommendation engines, one or more recommendation domains, and one or more delivery channels. The recommendation engines may be configured to generate suggestions based on various inputs, including but not limited to: competitor activity, sales anomaly root cause analysis (RCA), passenger (Pax) reviews, predefined rules, and adjacent task force (TF) data. The recommendation domains may include functional areas such as menu management, customer satisfaction, brand presentation, operations, inventory management, marketing, customer insights, financial services, and training. Delivery of the generated recommendations may occur through one or more channels, including, for example, an AI assistant interface, inbox notifications, and email communications. The module may further include a data store, implemented as a database, configured to persistently store recommendation-related attributes at the store ID level.

The merchant recommendation delivery system of the recommendation module 500 is configured to optimize conversion based on the recommendation domain, time/weekday of delivery and channel delivery.

The system 100 may be incorporated with a centralized recommendation engine configured to generate and deliver tailored, context-aware suggestions to merchants. These recommendations are generated based on multiple parameters, including the applicable recommendation domain such as menu optimization, promotional campaign strategies, or order flow management, timing logic to identify optimal engagement windows (for example, prior to peak business hours), and the preferred communication channel, which may include the chatbot interface, email notifications, or in-dashboard alerts.

Within this architecture, the AI assistant embedded in the system 100 may be configured to function as the primary interface for recommendation delivery. The system 100 may present actionable suggestions using structured user interface elements, notably action cards, that enable merchants to directly review and act upon system-generated recommendations. For example, upon detecting a decline in weekday lunch sales, the system may generate a prompt stating: “Your weekday lunch sales are slowing down. Would you like to set up a 10% lunch discount to attract more customers?”. Accompanying this prompt is an action card that allows the user to approve, modify, or decline the proposed discount, thereby providing convenience and maintaining user control over business decisions.

The integration of push recommendation capabilities with chitchat functionality allows the chatbot system 100 to operate both reactively, responding to user queries, and proactively, initiating engagement based on real-time business context. This combined approach enhances merchant engagement and drives operational efficiency.

The recommendation module 400 may be built upon a modular and extensible framework that leverages domain-specific processing modules, hierarchical prompt structures, historical session data stored within the contextual memory unit 118, and a centralized tool repository. This architecture supports accurate query routing, real-time data access, and user-authorized execution of critical business operations, thereby streamlining workflows and reducing manual effort.

In further embodiments, the system 100 may employ advanced machine learning techniques for dynamic domain classification and personalized response generation based on historical user interactions and merchant behavior profiles. These enhancements aim to continually improve automation, decision support, and overall user satisfaction within the chatbot environment.

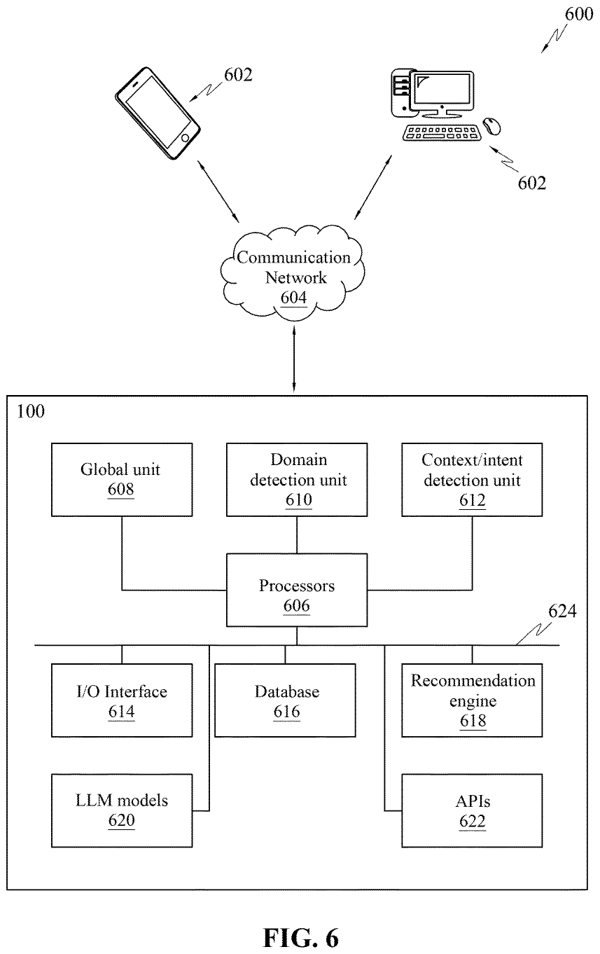

Referring to FIG. 6, an exemplary computing environment on which an embodiment described herein may be implemented is disclosed. An exemplary computing environment suitable for implementing one or more embodiments described herein is presented below. This computing environment is provided for illustration only and should not be construed as limiting the scope or functionality of any embodiment described herein. References to known computing components and processes are not intended to suggest that any of the embodiments disclosed are mere aggregations of such known elements. Rather, the disclosed embodiments involve specific configurations and programming that result in specially adapted machines for carrying out the described methods and systems.

The exemplary environment comprises one or more client devices 602 and system 100 disposed on a remote server configured to communicate over a communication network 604.

In an embodiment, the one or more client devices 602 may comprise computing devices operable by end users or business operators, such as desktop computers, laptops, smartphones, tablets, point-of-sale (POS) terminals, kiosks, or wearable devices. These client devices 602 may include one or more processors, memory, display interfaces, input/output subsystems, and network communication hardware. Each client device 602 is configured to execute a user interface application, such as a web-based dashboard, a mobile app, or a voice interface, through which the user may interact with the chatbot system 100 via text, audio, or video modalities.

In an embodiment, the client devices 602 may be configured to render interactive elements such as action cards, receive and transmit user input, and display system responses generated by the chatbot system 100. These interactions may be facilitated via a graphical user interface (GUI), voice synthesis and recognition engines, or multimodal interfaces. The client devices 602 may be further configured to transmit contextual metadata, such as user identifiers, roles, geolocation data, and session tokens, as part of each interaction.

In an embodiment, the communication network 604 may be configured to enable secure, bidirectional data exchange between the client devices 602 and the chatbot system 100 deployed on remote servers. It may include a combination of public and private networks, such as the Internet, VPNs, LANs, and wireless cellular networks (e.g., 4G, 5G), and supports various communication protocols including HTTPS, WebSockets, and gRPC. The network facilitates real-time and asynchronous interactions across text, audio, and video modalities, and may incorporate encryption, authentication, and API gateway layers to ensure data integrity and access control. Additionally, the network may interface with external systems, such as POS or analytics platforms, to support backend operations triggered by user interactions.

In an embodiment, the system 100 as implemented on the remote server, comprises at least one processor 606 (or a cluster of processors). The one or more processors 606 may be configured to execute the core logic of the adaptive multi-domain chatbot, and comprises of specialized subcomponents such as a domain detection unit 610, a global unit 608, and a context/intent detection unit 612. These modules may be configured to operate collectively to classify incoming queries, apply enterprise-level interaction policies, and infer user intent based on both semantic input and contextual metadata.

In an embodiment, the system 100 comprises of at least one processor 606, which may be implemented using one or more processors configured in hardware, software, firmware, or any suitable combination thereof. The processor 606 may comprise central processing units (CPUs), graphics processing units (GPUs), or other specialized processing hardware such as TPUs or FPGAs, depending on system requirements. The processor 606 may be operatively coupled to other system components via a system bus 624 and is responsible for coordinating and executing the core functions of the chatbot system 100. In software or firmware-based implementations, the processor 602 may execute computer-executable instructions stored in database/memory. These instructions may be written in any suitable programming language and are configured to perform operations such as domain detection, intent classification, context management, tool invocation, recommendation generation, and system orchestration. In distributed environments, multiple processor instances may operate in parallel across cloud or edge infrastructure to support scalable and real-time performance.

In an embodiment, the system 100 further comprises of input/output (I/O) interface 614, which is configured to manage communication between the system 100 and external devices or networks. The I/O interface 614 may include hardware and software components capable of receiving user input in multiple modalities, including text, voice, and video, and transmitting system responses or interactive elements such as action cards. It may also support integration with peripheral devices such as microphones, cameras, touchscreens, keyboards, and display panels. The I/O interface 614 may be operatively coupled to the processor 606 and other system components via the system bus 624, and is responsible for formatting, routing, and validating incoming and outgoing data. In some embodiments, the I/O interface 614 may support communication over various protocols such as HTTP, HTTPS, WebSockets, gRPC, or proprietary APIs, enabling seamless interaction with client devices, external systems, and third-party platforms. The I/O interface 614 may also include input filters and output formatting logic aligned with system-wide configuration parameters defined by the global unit 608.

In an embodiment, the database 616 may be configured to store both persistent and transient data used by the one or more processors 606 during execution. The database 616 may include a combination of volatile memory (e.g., random-access memory or RAM) and non-volatile memory (e.g., solid-state drives, hard disk drives, or flash memory). It may also support removable or external memory such as CompactFlash cards, Secure Digital (SD) cards, or other portable storage formats. The database 616 may be implemented in the form of primary and secondary storage, providing dedicated locations for system instructions, intermediate computations, and long-term data persistence. The database 616 may be configured to store executable program instructions, configuration parameters, and system-wide data including user profiles, contextual memory states, session histories, access control rules, and interaction logs. The database 616 may also retain pre-trained language model parameters, tool invocation mappings, and rule sets for domain-specific modules. During operation, the processors 606 may be configured to retrieve, update, and write data to the database 616 to support real-time conversation handling, tool execution, personalization, and recommendation generation. The memory module may be implemented using relational databases, NoSQL databases, key-value stores, or in-memory data grids, depending on performance and consistency requirements.

In an embodiment, the recommendation engine 618, as illustrated and described with reference to FIG. 5, which is configured to generate personalized, context-aware, and domain-specific suggestions for users. The recommendation engine 618 may be configured to analyze real-time operational data, user behavior patterns, historical interaction logs, and business performance metrics to determine relevant actions or insights. These recommendations may comprise of promotional campaign suggestions, inventory alerts, pricing optimizations, or engagement nudges, depending on the functional domain associated with the current user interaction. The recommendation engine 618 may operate in conjunction with the domain detection unit 610, contextual unit 612, and one or more large language models 620 to construct structured outputs such as action cards or system-generated prompts. The recommendation engine 618 comprises of rule-based logic, statistical models, or machine learning algorithms to evaluate thresholds, detect anomalies, or forecast trends. The generated recommendations may be delivered to users proactively or in response to specific queries, and are rendered via the output unit in an interactive format that supports user approval, modification, or dismissal.

In an embodiment, the one or more large language models (LLMs) 620 may be configured to facilitate natural language understanding, semantic interpretation, prompt generation, and dynamic response formulation. The LLMs 620 may be implemented as fine-tuned transformer-based architectures, such as GPT, BERT, or other foundation models trained on large-scale corpora. These LLM models 620 may be hosted locally within the system infrastructure or accessed via secure API calls to third-party AI service providers, depending on performance, latency, and deployment constraints. In operation, the LLMs 620 may be invoked by domain-specific modules, the context/intent detection unit 612, or the recommendation engine 618 to perform functions such as query interpretation, entity extraction, contextual reasoning, and natural language generation. The LLM models 620 may consume structured prompts assembled from contextual memory and system parameters, and return structured or free-text outputs for further processing or presentation. Multiple LLM model 620 instances may be used concurrently for different business domains or user roles, and their outputs may be filtered or refined by post-processing logic in accordance with global configuration policies.

In an embodiment, the one or more Application Programming Interfaces (APIs) 622 may be configured to facilitate secure and structured communication between internal system components and external platforms. These APIs may be implemented using standard protocols such as REST, gRPC, GraphQL, or WebSockets, and are operable to transmit and receive data related to user queries, system responses, tool executions, business metrics, and action card payloads. The APIs 622 enable seamless interoperability with merchant systems, including point-of-sale (POS) platforms, inventory databases, analytics engines, marketing dashboards, and third-party messaging services. Internally, APIs 622 may also be used to execute data flow between system modules such as the domain detection unit 610, recommendation engine 618, context/intent detection unit 612, and among others. These interfaces ensure modularity, scalability, and abstraction of functionality, allowing components to evolve independently while maintaining system cohesion. The APIs 622 may be secured through authentication mechanisms such as OAuth 2.0, API keys, or mutual TLS, and may include rate limiting, logging, and access control layers to enforce security, privacy, and compliance policies.

In an embodiment, the components of the system 100, including the processors 606, I/O interface 614, database 616, large language models 620, recommendation engine 618, and APIs 622, among others may be configured to communicate with each other via a system bus 624. The system bus 624 may be configured to provide a communication backbone that facilitate structured, high-speed data exchange and synchronization between functional modules. The system bus 624 may include one or more hardware and/or software-based interconnects, such as parallel buses, serial buses, or message-passing interfaces, and may support point-to-point or broadcast communication patterns. The system bus 624 may be configured to support event-driven, synchronous, or asynchronous communication, depending on the operational requirements of each module. The system bus 624 may be implemented using technologies such as shared memory, message queues, middleware brokers (e.g., RabbitMQ, Kafka), or internal API layers. It ensures modularity, scalability, and coordination across the distributed system, enabling coherent and low-latency execution of chatbot workflows, real-time tool invocation, and context-aware recommendation delivery.

In an embodiment, the global unit 606 may functionally correspond to the global unit 114 described in earlier embodiments. Likewise, the domain detection unit 610 may be equivalent to the domain detection unit 110, and the processors 606 may correspond to the processing circuitry 104. Additionally, the system bus 624 may be functionally equivalent to the communication channel 108 described in the previous embodiment, and may be configured to facilitate inter-component communication across the system.

In an embodiment, a non-transitory computer-readable medium may be provided, wherein the non-transitory computer-readable medium stores instructions that, when executed by one or more data processing devices, cause the devices to perform the methods and processes described herein. The non-transitory computer-readable medium may include, but is not limited to, magnetic disks, optical disks, solid-state drives, flash memory, or any other suitable medium capable of storing executable instructions. When operably connected to a processing system configured to execute such instructions, the stored program code enables the system to carry out the functionalities and operations as set forth in the foregoing description.

It shall be noted that the processes described above are described as sequence of steps; this was done solely for the sake of illustration. Accordingly, it is contemplated that some steps may be added, some steps may be omitted, the order of the steps may be re-arranged, or some steps may be performed simultaneously. Although embodiments have been described with reference to specific example embodiments, it will be evident that various modifications and changes may be made to these embodiments without departing from the broader scope of the system 100 and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications; these should not be construed as limiting the scope of the invention but as merely providing illustrations of some of the personally preferred embodiments of this invention. Thus, the scope of the invention should be determined by the appended claims and their legal equivalents rather than by the examples given.

What is claimed is:

1. A method for implementing a chatbot, the method being performed by one or more processors, the method comprising:
receiving a user query in one or more modalities including text, audio, or video;
determining a relevant functional domain for the user query based on user-specific contextual data;
routing the query to a domain-specific processing module among a plurality of modules, each configured to perform operations related to a distinct functional domain associated with the user;
selecting and executing one or more tool from a centralized tool repository, each tool configured to process data associated with the identified functional domain based on the domain-level contextual data;
generating one or more action cards based on output received from the selected and executed tool, wherein each action card enables user interaction;
presenting the one or more action cards, on a graphical user interface, to enable user interaction with the one or more action cards; and
executing one or more operation associated with the one or more action cards based on the inputs received from the user in response to the one or more action cards.

2. The method as claimed in claim 1, further comprises identifying an intent of the user based on the received query, wherein the routing of the query to the domain-specific processing module is based on the identified intent of the user.

3. The method as claimed in claim 1, wherein:
the user-specific contextual data comprises at least one of user identifier, a role designation indicating the user's access level and a list of domain-specific modules permitted for the user; and
the domain-level contextual data comprises at least one of a domain identifier corresponding to the selected functional domain and operational parameters relevant to the identified domain.

4. The method as claimed in claim 3, wherein determining the relevant functional domain comprises:
dynamically generating a domain specific prompt based on the user-specific contextual data; and
providing the generated domain specific prompt as input to the domain detection unit for selecting the relevant functional domain among a plurality of functional domains.

5. The method as claimed in claim 1, wherein each domain-specific module is configured with access to the centralized tool unit, the centralized tool unit comprising:
one or more data retrieval tools configured to access structured business data from integrated systems comprising at least one of point-of-sale databases, sales analytics engines, and inventory systems; and
one or more action-triggering tools configured to construct executable signals for backend task execution.

6. The method of claim 1, wherein each action card comprises one or more user-selectable options to confirm, modify, or cancel a proposed operation.

7. The method as claimed in claim 1, further comprises applying a set of system-level configuration parameters to standardize and constrain response generation across domain-specific modules.

8. The method as claimed in claim 7, wherein the set of system-level configuration parameters comprising at least one of response tone specifications, output formatting rules, regulatory compliance constraints, and interaction behavior profiles.

9. A chatbot system comprising one or more processors, the system configured to:
receive a user query in one or more modalities including text, audio, or video; determine a relevant functional domain for the user query based on user-specific contextual data;
route the query to a domain-specific processing module among a plurality of modules, each configured to perform operations related to a distinct functional domain associated with the user;
select and execute one or more tool from a centralized tool repository, each tool configured to process data associated with the identified functional domain based on the domain-level contextual data;
generate one or more action cards based on output received from the selected and executed tool, wherein each action card enable user interaction;
present the one or more action cards, on a graphical user interface, to enable user interaction with the one or more action cards; and
execute one or more operation associated with the one or more action cards based on the inputs received from the user in response to the one or more action cards.

10. The system as claimed in claim 9, wherein the system is further configured to identify an intent of the user based on the received query, wherein the routing of the query to the domain-specific processing module is based on the identified intent of the user.

11. The system as claimed in claim 9, wherein:
the user-specific contextual data comprises at least one of user identifier, a role designation indicating the user's access level and a list of domain-specific modules permitted for the user; and
the domain-level contextual data comprises at least one of a domain identifier corresponding to the selected functional domain and operational parameters relevant to the identified domain.

12. The system as claimed in claim 11, wherein the domain detection unit is configured to:
dynamically generate a domain specific prompt based on the user-specific contextual data; and
provide the generated domain specific prompt as input to the domain detection unit for selecting the relevant functional domain among a plurality of functional domains.

13. The system as claimed in claim 9, wherein each domain-specific module is configured with access to the centralized tool unit comprising:
one or more data retrieval tools configured to access structured business data from integrated systems comprising at least one of point-of-sale databases, sales analytics engines, and inventory systems; and
one or more action-triggering tools configured to construct executable signals for backend task execution.

14. The system as claimed in claim 9, wherein each action card comprises one or more user-selectable options to confirm, modify, or cancel a proposed operation.

15. The system as claimed in claim 9, further comprises a global control unit configured to apply a set of system-level configuration parameters to standardize and constrain response generation across the domain-specific modules.

16. The method as claimed in claim 15, wherein the set of system-level configuration parameters comprises at least one of response tone specifications, output formatting rules, regulatory compliance constraints, and interaction behavior profiles.

17. A non-transitory computer-readable medium storing instructions that, when executed by one or more processors of a system, cause the system to perform a method for facilitating a chatbot system, the method comprising:
receiving a user query in one or more modalities including text, audio, or video; determining a relevant functional domain for the user query based on user-specific contextual data;
routing the query to a domain-specific processing module among a plurality of modules, each configured to perform operations related to a distinct functional domain associated with the user;
selecting and executing, based on domain-level contextual data, one or more tool from a centralized tool repository, each tool configured to process data associated with the identified functional domain based on the domain-level contextual data;
generating one or more action cards based on output received from the selected and executed tools, wherein each action card enable user interaction;
presenting the one or more action cards, on a graphical user interface, to enable user interaction with the one or more action cards; and
executing one or more operation associated with the one or more action cards based on the inputs received from the user in response to the one or more action cards.
